(19) United States
(12) Patent Application Publication
(10) Pub. No.: US 2014/0118632 A1
(43) Pub. Date: May 1, 2014

(54) PROJECTED CAPACITIVE TOUCH PANEL

(71) Applicant: Abon Touchsystems Inc., Yilan County (TW)

(72) Inventor: Tse-Kun Chang, Yilan County (TW)

(21) Appl. No.: 13/909,915

(22) Filed: Jun. 4, 2013

(30) Foreign Application Priority Data
Oct. 29, 2012 (TW) 101220882

(51) Int. Cl. G06F 3/044

(52) U.S. Cl. CPC G06F 3/044
USPC 349/12

(57) ABSTRACT

In a projected capacitive touch panel, an isolation layer is formed on a frame region of a first transparent substrate, and a first transparent conductive circuit layer is formed on the other region of the first transparent substrate and the isolation layer; a first conductive layer is formed on the first transparent conductive circuit layer and is positioned corresponding to the frame region; a second transparent conductive circuit layer is formed on the transparent substrate film; two second conductive layers are formed on the second conductive circuit layer and are positioned corresponding to two opposing sides of the frame region; flexible circuit boards are connected to the first and second conductive layers and are positioned corresponding to the same side of the frame region.

### RELATED APPLICATIONS

This application claims priority to Taiwan Application Serial Number 101220882, filed Oct. 29, 2012, which is herein incorporated by reference.

### BACKGROUND

1. Technical Field

The present disclosure relates to a touch panel, and more particularly, a high-transmittance miniaturized projected capacitive structure.

2. Description of Related Art

Touch panels are widely used in existing devices, such as automatic teller machines, point of sale terminals, industrial control systems. Because this interface is easy to use, durable, and is not expensive, the market has experienced continued rapid growth.

Currently available projected capacitive touch panels have wide borders that are undesired for the markets. In view of the foregoing, there exist problems and disadvantages in the current touch panels that await further improvement. However, those skilled in the art sought vainly for a solution. Accordingly, there is an urgent need in the related field to provide a solution that narrows the panel border.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to a next-generation touch panel that has a narrow border.

According to one embodiment of the present invention, a projected capacitive touch panel includes a first transparent substrate and a second transparent substrate, an isolation layer, a first and second transparent conductive circuit layer, a first and a second conductive layers, an adhesive layer, and flexible circuit boards. The isolation layer is formed on a frame region at one surface of the first transparent substrate, and the first transparent conductive circuit layer is formed on the other region at said surface of the first transparent substrate and the isolation layer. The first conductive layer is formed on the first transparent conductive circuit layer, and is positioned corresponding to the frame region. One surface of the adhesive layer is in direct contact with the first conductive layer and the first transparent conductive circuit layer, whereas the second transparent substrate is in direct contact with the other surface of the adhesive layer. The second transparent conductive circuit layer is formed on the second transparent substrate. The second conductive layers are formed on the second transparent conductive circuit layer and are positioned corresponding to two opposing sides of the frame region. A plurality of flexible circuit boards are respectively connected to the first and second conductive layers, and are positioned corresponding to the same side of the frame region.

The projected capacitive touch panel further comprises a circuit control board. The circuit control board is connected to the plurality of flexible circuit boards.

The adhesive layer may be an optical cement layer.

The first conductive layer may be a first conductive ink pattern.

The second conductive layer may be a second conductive ink pattern.

The isolation layer may be a decorative layer.

The first transparent substrate is a single-piece glass substrate.

The second transparent substrate is a single-piece glass substrate or a transparent substrate film.

The technical solution of the present disclosure, as discussed above, provides many advantages and beneficial effects compared with conventional techniques. Because of the technical inventiveness and utility of the present technical solution, it could be widely used in the industry. Technical advantages are generally achieved, by embodiments of the present invention, as follows:

(1) The signals of the two conductive circuit layers are directed to the outgoing lines at the same side and then connected to a plurality of flexible circuit boards, thereby narrowing the border and achieving an utmost narrow border.

(2) The manufacturing process is simplified, thereby increasing the yield rate.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is an exploded drawing illustrating a projected capacitive touch panel according to one embodiment of the present disclosure;

FIG. 2 is a top-view drawing illustrating a projected capacitive touch panel according to one embodiment of the present disclosure; and

FIG. 3 is a sectional view taken from the line 3-3 in FIG. 2.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise.

The terms “about”, “approximately” and “substantially” are used herein to modify numeral values that may subject to slight variations, yet such variations would not alter the nature of the numeral values. According to embodiments herein, “around”, “about” or “approximately” shall generally mean within 20 percent, preferably within 10 percent, and more preferably within 5 percent of a given value or range, unless otherwise defined.

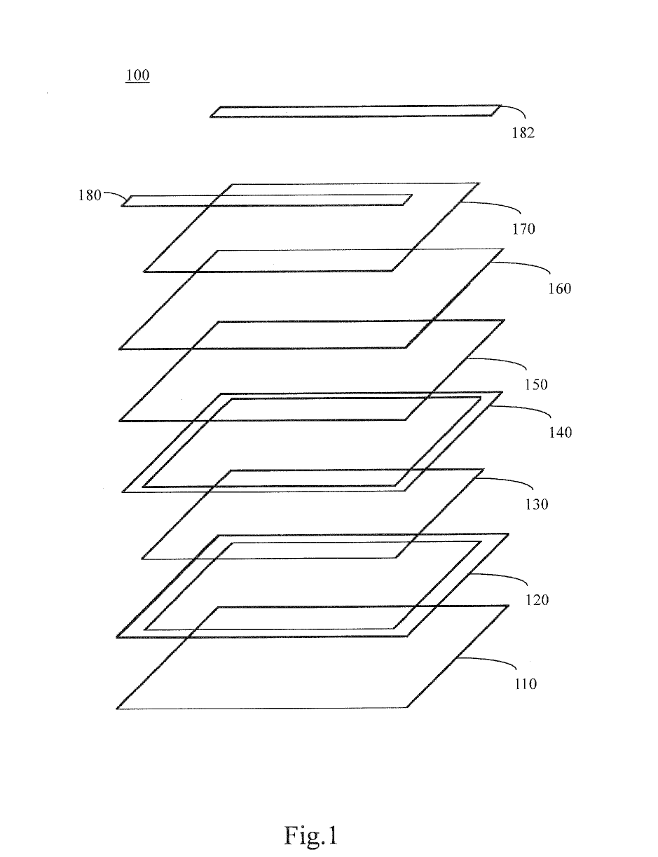

FIG. 1 is an exploded drawing illustrating a projected capacitive touch panel 100 according to one embodiment of the present disclosure. As illustrated in FIG. 1, the projected capacitive touch panel 100 comprises a first transparent substrate 110, an isolation layer 120, a first transparent conductive circuit layer 130, a first conductive layer 140, an adhesive layer 150, a second transparent substrate 160, a second transparent conductive circuit layer 170, and second conductive layers 180 and 182.

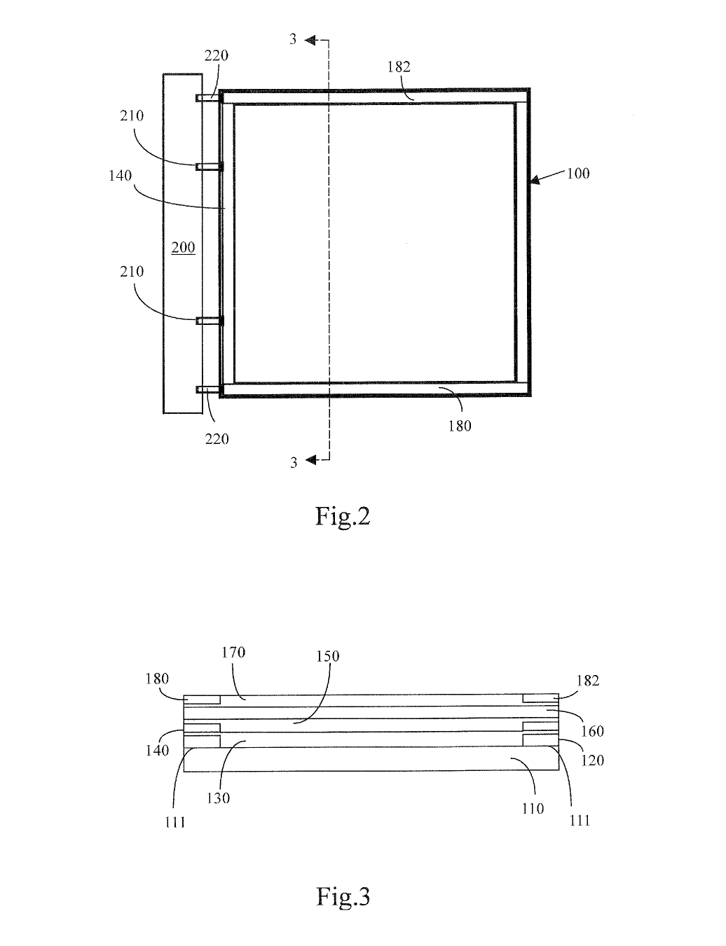

In manufacturing process, the isolation layer 120 is formed on the first transparent substrate 110, and then the first transparent conductive circuit layer 130 is formed on the first transparent substrate 110 so that the first transparent conductive circuit layer 130 is used the conductive circuit layer of an operation plane. Next, the first conductive layer 140 is formed on the first transparent substrate 110 so that the first conductive layer 140 is electrically connected to the first transparent conductive circuit layer 130. In operation, the first transparent conductive circuit layer 130 may conduct the signal via the first conductive layer 140 and the flexible circuit board 210 (illustrated in FIG. 2) to the circuit control board 200 (illustrated in FIG. 2).

On the other hand, after a transparent conductive layer is formed on the second transparent substrate 160, the transparent conductive layer is made into the second transparent conductive circuit layer 170; next, the second conductive layers 180 and 182 are further formed on the second transparent conductive circuit layer 170, in which the second conductive layers 180 and 182 are electrically connected to the second transparent conductive circuit layer 170. In operation, the second transparent conductive circuit layer 170 may conduct the signal via the second conductive layers 180 and 182 and the flexible circuit board 220 (illustrated in FIG. 2) to the circuit control board 200 (illustrated in FIG. 2).

Therefore, the projected capacitive touch panel 100 may comprise a semi-finished first substrate (which comprises the first transparent substrate 110, the isolation layer 120, the first transparent conductive circuit layer 130, and the first conductive layer 140) and a semi-finished second substrate (which comprises the second transparent substrate 160, the second transparent conductive circuit layer 170 and the second conductive layers 180 and 182). Finally, the semi-finished first substrate and the semi-finished second substrate are assembled with the adhesive layer 150, and the assembly is connected to the flexible circuit boards 210 and 220 and then connected to the circuit control board 200 to obtain a projected touch panel with a very narrow border. The present manufacturing process is a simplified process, and hence, the yield rate thereof is improved.

Regarding the specific structure of the projected capacitive touch panel 100, please refer to FIG. 3, which is a sectional view taken from the line 3-3 in FIG. 2. As illustrated in FIG. 3, the isolation layer 120 is formed on the frame regions 111 of one surface of the first transparent substrate 110, while the first transparent conductive circuit layer 130 is formed on the isolation layer 120 and the other region of said surface of the first transparent substrate 130. The first conductive layer 140 is formed on the first transparent conductive circuit layer 130, and is positioned corresponding to the frame region. One surface of the adhesive layer 150 is in direct contact with the first conductive layer 140 and the first transparent conductive circuit layer 130, whereas the second transparent substrate 160 is in direct contact with the other surface of the adhesive layer 150. The second transparent conductive circuit layer 170 is formed on the second transparent substrate 160. The second conductive layers 180 and 182 are formed on the second transparent conductive circuit layer 170, and are positioned corresponding to the two opposing site of the frame region 111.

In the present embodiment, the adhesive layer 150 may be an optical cement layer. The material of the first transparent substrate 110 and the second transparent substrate 160 may be, for example, an inorganic transparent material (e.g. glass, quartz, other suitable materials, or a combination of the above), an organic transparent material (e.g. polyolefin, polythiourea, polyalcohols, polyester, rubber, a thermoplastic polymer, a thermosetting polymer, polyarylene, polymethylmethacrylate, plastic, polycarbonate, other suitable materials, derivatives of the above, or a combination of the above), or a combination of the above. In one embodiment of the present disclosure, the first transparent substrate 110 is a single-piece glass substrate, and the second transparent substrate 160 is also a single-piece glass substrate or a single transparent substrate film (such as a polyester film).

Further, the first conductive layer 140 may be a first conductive ink pattern, and the second conductive layer 180 may be a second conductive ink pattern. For example, the material of the conductive ink pattern may be a carbon paste, a silver paste, other suitable materials, or a combination of the above. The isolation layer 120 may be a decorative layer, and this decorative layer may obscure the conductive ink pattern and allow the presentation of the frame pattern.

The material of the first transparent conductive circuit layer 130 and the second transparent conductive circuit layer 170 may be, for example, indium tin oxide (ITO), indium zinc oxide (IZO), indium tin zinc oxide (ITZO), hafnium oxide, zinc oxide, aluminum oxide, aluminum tin oxide (ATO), aluminum zinc oxide (AZO), cadmium tin oxide (CTO), cadmium zinc oxide (CZO), other suitable materials, or a combination of the above. In the manufacturing process, it may be feasible to form a transparent conductive material first, which is then patterned with suitable process to obtain the transparent conductive circuit layer.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.SC. §112 (f). In particular, the use of “step of” in the claims herein is not intended to invoke the provisions of 35 U.S.C. §112 (f).

What is claimed is:

1. A projected capacitive touch panel comprising:
a first transparent substrate;
an isolation layer, formed on a frame region of one surface of the first transparent substrate;
a first transparent conductive circuit layer, formed on the isolation layer and the other region of the surface of the first transparent substrate;
a first conductive layer, formed on the first transparent conductive circuit layer, and positioned corresponding to the frame region;
an adhesive layer, having one surface in direct contact with the first conductive layer and the first transparent conductive circuit layer;
a second transparent substrate, in direct contact with the other surface of the adhesive layer;
a second transparent conductive circuit layer, formed on the second transparent substrate;
two second conductive layers, formed on the second transparent conductive circuit layer, and are positioned corresponding to two opposing sides of the frame region; and
a plurality of flexible circuit boards, respectively connected to the first and second conductive layers, and positioned corresponding to the same side of the frame region.

2. The projected capacitive touch panel of claim 1, further comprising:
a circuit control board, connected to the plurality of flexible circuit boards.

3. The projected capacitive touch panel of claim 1, wherein the adhesive layer is an optical cement layer.

4. The projected capacitive touch panel of claim 1, wherein the first conductive layer is a first conductive ink pattern.

5. The projected capacitive touch panel of claim 4, wherein the second conductive layer is a second conductive ink pattern.

6. The projected capacitive touch panel of claim 4, wherein the isolation layer is a decorative layer.

7. The projected capacitive touch panel of claim 1, wherein the first transparent substrate is a single-piece glass substrate.

8. The projected capacitive touch panel of claim 1, wherein the second transparent substrate is single-piece glass substrate or a transparent substrate film.
